(19) United States
(12) Patent Application Publication
(10) Pub. No.: US 2020/0231508 A1
(43) Pub. Date: Jul. 23, 2020

(54) Compound Monolithic 3-D Fused FHD/S Products and Method

(71) Applicant: Joseph F. DeLorenzo, Torrence, CA (US)

(72) Inventor: Joseph F. DeLorenzo, Torrence, CA (US)

(21) Appl. No.: 16/253,031

(22) Filed: Jan. 21, 2019

(51) Int. Cl. C04B 37/00

(52) U.S. Cl. CPC C04B 37/003; C04B 2237/341; C04B 2237/86; C04B 2237/80; C04B 2237/10

(57) ABSTRACT

Fused, monolithic 3-D products of high-SiO2-containing body materials, called FHD/S, cut to pattern, mating surfaces honed or polished, assembled with mating surfaces in contact, and fusion fired until the contacting parts fuse without added flux. Fused FHD/S products may be used unglazed, or glaze may be applied to selected fused surfaces and then glaze fired. FHD/S body materials may include colorants so that the fused parts exhibit color contrast and variation when used without glazing. Examples include countertops having integral fused vertical back-splashes and front edges, and bowls fused to openings. The inventive 3-D monolithic fused FHD/S products are produced in standard sizes or as custom-fit interior and exterior products that are stain resistant, moisture impervious, UV resistant, acid resistant, dimensionally stable, abrasion and impact resistant, and may be glazed to produce unique decorative and utilitarian surfaces in a wide range of colors and textures, including artistic, one-of-a-kind 3-D works.

### CROSS-REFERENCE TO RELATED APPLICATIONS

This is a CIP of U.S. application Ser. No. 15/009,548 filed Jan. 28, 2016, published on Aug. 11, 2016 as US 2016-0230396, now U.S. Pat. No. 10______, titled Process for Production of Glazed, High Density Engineered Surface Products and Products Thereof, which is the Regular Application of US Provisional Application filed on Feb. 6, 2015, Ser. No. 62/113,286, titled Process for Production of Glazed, High Density Engineered Surface Products, the benefits of the filing dates of both of said applications are claimed under 35 USC 119 ff.

### FIELD

This invention relates to the field of pre-fabricated, custom, fused, and optionally glazed, compound 3-D, high density, high-SiO₂-containing, fine-grained, engineered products, including solid surface products such as: countertops; table tops; bench tops; worktops; back splashes; sinks; vanity tops; shower flooring; main flooring; and other architectural surfaces, such as vertical wall surfaces and decorative panels. More specifically the invention relates to a method of manufacture of 3-D, fusion-constructed, compound-shape, monolithic, robust, unitary custom-fit interior and exterior high-SiO₂-containing, fine-grained, glazed and unglazed engineered solid surface products that are stain resistant, moisture impervious, UV resistant, acid resistant, dimensionally stable, strong, abrasion and impact resistant, and may be glazed to produce unique decorative and utilitarian surfaces in a wide range of colors and textures, including artistic, one-of-a-kind works.

### BACKGROUND

A wide range of high-density solid surface counter-top materials are available to home-owners, home remodelers, contractors and architects from among which to select, depending on use and décor needs. High density solid surface materials as referred-to herein are a class that excludes wood and the laminates such as Formica (Formica Group, NZ) and Wilsonart (ITW) and stainless steel, but includes natural materials such as marble, granite, soap stone, igneous lava-type materials such as basalt, and metamorphic materials such as slate, as well as man-made engineered slabs, such as cultured marble, concrete, quartz-containing slabs, vitreous ceramic tiles and glass or recycled glass, although there is a wide range of composition and density of those materials.

The current material of consumer choice is natural granite because of its hardness and beautiful range of colors and natural patterns of its crystalline components and veining. It can also be diamond polished to a high gloss. However, granite is porous, prone to growing molds and staining. Thus, a granite surface requires a sealant that must be periodically re-applied. In addition, granite is provided in 2-D slabs which must be cut, fitted and glued or grouted together in order to form compound, 3-D shapes, such as a kitchen or bathroom countertop having a backsplash. The resulting compound product has grout or glue lines that require cleaning and restoration maintenance and are prone to separation over time.

The class of high density solid surface materials involved herein, also termed unitary or slab materials, are distinct from ceramic tiles in that they are self-supporting over large areas and are typically installed without backing mastic and grouted seams when used as horizontal surfaces such as kitchen counter-tops, tables, side-boards, shelving, sills and the like. Solid surface materials, depending on the size, may be installed on vertical surfaces using mastic, a silicone-based adhesive, or silica gel, the latter used in high temperature environments such as in the case of a fireplace surround, or by use of mechanical fasteners suitably engaging the slabs and the wall support elements.

There are currently two Categories (types) of man-made commercially-available unitary solid surface, engineered materials: A, engineered materials employing a polymer matrix made in a low-temperature process by casting, and B, high temperature-fired engineered materials involving vitrification, sintering, semi-sintering, or some degree of surface softening of SiO₂ component particulates to permit bonding into a relatively monolithic slab.

However, polymer matrix-bonded engineered materials of Category A are highly UV sensitive, resulting in their change of color and degrading over time when exposed to light. Thus, such materials are not recommended or warranted for exterior use, such as out-door cook-tops, tables, benches or vertical architectural panels. They also have a relatively low cut and abrasion resistance, and some may discolor when a hot pan is placed on the surface, that is, they will exhibit “burn” marks. While abrasion marks may be buffed out, cuts and gouges have to be filled with acrylic or polyester epoxy resins, then polished.

Non-exhaustive or inclusive examples of man-made Category A materials include such well-known brands as Corian (DuPont), Caesarstone (Caesarstone Sdot-Yam, IL; Caesarstone Intl, US), Silestone (Cosentino, SA), Swanstone (Swan Co.), Staron (Samsung), Zodiaq (DuPont), Avonite (Aristech), Hanex (Hanwha Living & Creative, KR), Hi-Macs/Viatera (LG Hausys, KR). These products comprise stone powder and/or granules retained in a plastic matrix, such an acrylic, polyester or polyurethane polymer, co-polymer or ter-polymer. Most include binders and colorants to provide monolithic color, so that cut edges have the same color throughout. One of the earliest materials was “cultured marble” comprising high strength polyester resin and real marble stone dust.

Corian is the brand name of DuPont for a solid surface material made of an acrylic polymer and alumina trihydrate, derived from bauxite ore. Zodiaq, another DuPont product, is an engineered surface comprising 93% quartz crystal and 7% acrylic resin. Zodiaq is non-porous and does not require a sealant. The color of Zodiaq is uniform throughout. Silestone, an engineered quartz surface product made by Cosentino SA, is 94% quartz, 6% polymer matrix that includes a silver ion-providing component to retard the propagation of bacteria on the surface. Other materials in this class include: Bretonstone, Cambria, Viatera, Radianz, Technistone, Okite, Avanza, Compac, Vicostone, and Qortstone, all of which include quartz as the major inorganic component (80-95%) and are believed to be based on Breton's process covered by EP patent(s).

Non-exhaustive or inclusive examples of Category B, high-SiO-containing, materials include Dekton (Cosentino, SA) and Lapitec (Breton, FR). Both are produced in a high temperature process. Lapitec is an inorganic ceramic material, e.g., sand, sintered at about 1200° C. to produce “full body” (understood to mean monolithic) slabs. See, Toncelli et al, U.S. Pat. No. 7,550,106. Dekton is a proprietary product involving densification of quartz particulates followed by semi-sintering with small amounts of flux to produce a fine-grained monolithic slab product. In both materials, there is a limited color palette based on inorganic colorant components mixed into the materials prior to firing resulting in uniform color throughout the thickness of the material. These Category B materials may be exposed to sunlight, such as outdoors or where exposed in interiors, without degradation.

The Category A polymer slab materials may be formed in a single step as compound, 3-D shapes as they are cast from a viscous resin, and then cured to form a monolithic compound shape. However, the Category B slab materials cannot be formed into monolithic compound, 3-D shapes, but rather are initially made only in 2-D slabs. In order to make a compound shape of a Category B material, slabs are cut apart, and then the parts are glued together, e.g., a vertical backsplash glued to a horizontal countertop, typically with a urethane or silicone glue at the installation site. However, such non-monolithic constructed 3-D shapes have the disadvantages of requiring cleaning and maintenance of the glue or grout lines, and may, over time and with use, be subject to separation of the parts. The gluing of separate parts to make a compound, 3-D shape results in the finished product not being robust as a free-standing product. Rather, the long term stability is in large part dependent on being bonded, secured or otherwise fastened to supports, such as wall studs, or base support frameworks.

Another current trend is production of large tiles or slab surfaces of vitreous ceramic, such as sanitary ware, onto which surface decals are applied and fired. The decals currently mimic natural stone surfaces, typically marble, or images. However, the decal is a thin surface-feature only, which is revealed when an edge is cut. Thus, the fired surface design does not flow over onto an exposed edge, such as the front edge of a kitchen counter, or the revealed edge for an under-mounted sink. Although it is possible to fold a decal over the edge, the result is a face design or image that unnaturally flows over the edge. In addition, sanitary ware, being nominally thin, e.g., typically on the order of ½″-1″ thick, are relatively fragile, subject to cracking when stressed or struck, and can fracture easily when implements are dropped onto the surfaces or they are not glued evenly to supporting surfaces, such as sub-floors or supporting plywood sheeting for under-counter bases or wall sheathing (as in bathrooms).

Accordingly, there is an unmet need in this art for a true design break-out for production of man-made, permanent solid surface, high SiO₂-containing Category B materials, that are robust, universal in use, both indoors and outdoors, have high strength, are non-porous, typically do not require surface sealing, have design elements that flow over corners including complex shapes, do not require on-the job cutting and gluing for fitting of sinks or faucets, can be custom pre-designed and shop prefabricated into compound, unitary 3-D shapes for on-site installation with minimal cutting and fitting, are capable of being highly and artistically decorated by glazing during fabrication as an architectural and design element and are priced competitively to currently available solid surface materials.

### THE INVENTION

### Summary

The invention comprises a method for manufacture of man-made (fabricated), custom pre-designed, pre-cut, unglazed and glazed (or “stained”), high SiO₂-containing, fine-grained, products having compound, monolithic 3-D shapes produced by fusion of like components, without casting. The inventive products are stain resistant, resistant to ordinary culinary acids, moisture impervious, UV resistant, dimensionally stable, strong and robust including abrasion and impact resistant, and have unique decorative and utilitarian surface-design features in a wide range of colors and textures, including artistic, one-of-a-kind works. The compound fused products may be produced in a shop or factory, ready for installation on a use site.

Accordingly, the invention comprises compound monolithic 3-D fused products, and methods of manufacture of the inventive products by firing an assemblage of engineered component body parts that are placed in close, mating contact, at a temperature and for a time sufficient to form a strong bond by contact fusion of the components to each other, thereby creating the inventive monolithic 3-D product. The unique character of the component engineered body material, comprising 80% or more and preferably 90% or more, fired SiO₂, enables the bond-by-contact-fusion of the invention.

As used herein, the component engineered body material will be referred-to by the acronym “FHD/S”, for Fired High Density, High SiO₂ engineered body material, as a short-hand mnemonic for the full description, in order to distinguish it from a ceramic, such as sanitary ware (which typically has only 60-65% SiO₂ and high content of kaolin, resulting in a mullite/glass material).

To date, SEM cross-sectional views of the fusion bond interface, shows it can be characterized as thin, typically on the order of from <1μ to 5μ (wide) for polished mating surfaces, and occasionally short lengths up to 50p. The SEM studies do not clearly show there is growth of a crystal phase across the interface. However, crystal growth in, or across, the fusion bond interface cannot be ruled out, because the fusion bond between the parts is qualitatively very strong and some CaSiO₃ (Wollastonite) is shown to be present in XRD analysis. As CaSiO₃ is known to easily recrystallize in a glass phase at elevated temperatures (>2000° F.), Wollastonite crystals could contribute to the bond strength. Accordingly, fused FHD/S bonds may include presence of Wollastonite, on the order of up to 5 weight percent.

The contact of crystals of each individual FHD/S engineered body part along the interface of the parts placed in contact, and the continuity of a thin glass phase across the fusion bond interface by migration of glass out of the FHD/S parts at the elevated fusion temperature, is an essential feature of the fusion bond join of the inventive compound products. In addition, the absence of excess glass phase at the interface, such as would occur with an excess of added melting glass to act as a “glue”, contributes to a stronger bond. Conversely, an excess of pure glass melting glue, having no crystalline content, is inherently less strong. As the interface bond glass phase is very thin, the presence of the crystals of the FHD/S engineered body parts, inhibits crack propagation in and across the bond. Occasional lengths of the interface bond, as seen in cross-section, can range in width up to about 50μ-150μ for short lengths; however, as the bond interface extends into the surface of the body, the depth of such lengths is shallow and filled with the glass phase melt.

Alternately, a small amount of an interface filler material, which melts at the fusion temperatures, may be used to assist in filling microscopic contact gaps of the interface plane that may be present. Examples of such interface filler material include suitable fluxes, or finely powdered (−325 to −200 mesh) body material, applied to one or both surfaces to be bonded prior to assembly for firing.

The inventive process permits production of custom-designed, large, complex 3-D FHD/S products without casting. The engineered component part body material contains 80% or more, and preferably 90% or more, fine-grained SiO₂ that is vibratory compacted and pressure compressed in a 2-step densification process, and then fired to produce the monolithic FHD/S slabs. The resulting FHD/S slabs have density in the range of from about 2.4-3 g/cc. The FHD/S slab bodies can be made with a wide range of surface textures and design features. The FHD/S body material is strong and robust, dimensionally stable, has excellent stain and UV resistance, is culinary acid proof, is moisture impervious, and has excellent impact and abrasion resistance.

While I do not wish to be bound by theory, SEM examination of the interface fusion bond between FHD/S body pieces indicates it is a glassy bond phase, which is believed to be formed by wicking into, diffusion, or flow across the join (interface gap), by migration of glass out of the individual mating FHD/S body pieces, and that on the order of 50% or more of the crystalline phase of each of the individual mating FHD/S body piece surfaces are in contact. The extent of the contact between the mating FHD/S body pieces is dependent upon the surface finish. For example the SEM studies indicate that for a robust bond, some 50% contact between the mating FHD/S body pieces is sufficient, and this amount of contact can be achieved as follows: Cutting the surfaces to be mated with a 120-220 grit diamond blade; Then the cut surfaces to be mated should be progressively wet-finished with a diamond router, an in-line edging machine, or a linear lapper, e.g., in multiple steps progressing to 400-600 diamond grit. The contacting surfaces of the FHD/S body pieces should be flat to form a uniformly strong bond.

It should be understood that the mating contact between the FHD/S body pieces be sufficiently close, flat and smooth to form no greater than a microscopic gap, typically on the order of <1μ-50μ, such that the glassy bond phase that exudes from or migrates out of the body pieces is wicked by meniscus forces to completely fill the gap.

### Body Production:

The inventive process includes preparing or selecting a high density, high SiO₂-containing, fine-grained, body material comprising in excess of 80%, and preferably 90% by weight SiO₂ material, having less than about 3% moisture and less than about 1% of an organic binder. The SiO₂ material is preferably high quality (natural impurities less than about 2%), fine-grained, crushed crystalline quartz material. By way of example, the fine-grained SiO₂ material may have a particle size distribution on the order of from about −325 to −200 mesh, up to larger particles in the range of from about +50 to −20 USS mesh. A mixture of a range of particle sizes is employed so that the finer particles fit in and interlock into the interstices of the larger particles. This assists in producing a strong, dense body material as a result of densification and firing. The fine-grained, high quality SiO₂ particulates are mixed with a minor amount of inorganic binder, such as Kaolinite or other clays containing Al₂O₃, typically less than 10%, and may also include less than about 10% Feldspar (a Ca, Mg, K, Na, Al—Silicate), Nephelene Seyenite (a Na—Silicate), Talc (a Mg—Silicate), and/or CaCO₃ as fluxes. No added colorants are required, but if a body color is desired, colorants may be added. All percentages are by weight.

The components may be mixed in the presence of a minor amount of water to produce a thick “paste” that is extruded as a wide, green slab body several inches thick onto a drying belt. The extruded green slab is sized for most common finished uses, such as 2-6′ width by 6′-12′ in length for home surface applications, and up to about 6′-8′ in width and 10′-60′ in length for commercial and architectural applications. Preferably, the extruded green slab may be subjected to multi-stage densification: First, vibratory compaction before or during extrusion, which assists in the inter-locking of the different-sized grains, and/or Second, pressure compaction during or after the extrusion step. The green slab is then dried to reduce the water content to <1% to produce a “green” slab body.

The green slab is then subjected to further densification by high pressure to reduce the thickness on the order of from about 10-25%, preferably at least 20%, which increases the density of the body (producing a densified slab of a selected thickness). At this stage, surface press-texturing (embossing) may be imparted to the top and % or bottom surface of the slab body by suitably-configured platens used in the press, by way of example, a wood grain or geometric pattern.

The pressure is removed and the selected-thickness (gauged), densified slab body is then fired at a temperature in the range of from about 1200° F. to about 2700° F. for a time sufficient to cause partial sintering of the fine-grain, high-SiO₂-containing, e.g., quartz, particulates to produce a finished thickness slab. For clarification, pre-fired materials are termed “particles” and the post-fired fused ones are termed “grains”, it being understood that the grains may include multiple crystals or/and re-grown crystals as a result of the firing.

In a subsequent, post-firing stage, thickness calibration and/or surface finishing may be imparted to the calibrated slab by machine finishing, such as grinding, honing, polishing, abrading and the like. This post-firing machine-finishing to produce a calibrated slab is to be distinguished from the press-texturing of the leather hard slab. In the case of pre-fired surface press-textured slabs, post-firing machine-finishing of the fired slabs is only selectively employed, for example to provide an additional, light abrasion or polishing effect to enhance the platen-textured surface. However, as described in more detail below, glazing of the press-textured surface is one of the important aspects of the inventive process.

In regard to the firing of the green (raw) slab body, complete melting of the component particulates is neither desired nor required. Glassification or vitrification of the body is also to be avoided. Rather, firing results in an ultra-dense, high-SiO₂-containing, fine-grained, monolithic body material that has excellent dimensional stability, having a Thermal Coefficient of Thermal Expansion (herein “CoE”) within the range of 5.8×10⁻⁶ to 8.5×10⁻⁶ m/m° C. The grains of the fired body may be characterized as surface bonded to each other, with the cores of the larger grains retaining their crystalline structure. A glassy phase flows around and encapsulates the grains so that the glass-forming components fill the interstices between larger grains and permits close packing re-arrangement of the fines. Upon cooling, the result is a monolithic, high density, high-SiO₂-containing, fine-grained, uniform body product having a Thermal Coefficient of Expansion in a range of 5.8-8.5×10⁻⁶ m/m° C. and density in the range of 2.4-3.0 grams/cm³. As noted above, the fired monolithic engineered body is called an “FHD/S body” for short.

Upon test breakage, the FHD/S body material has a uniform fracture surface, characterized as a smooth, fine-grained fracture surface, generally conchoidal in nature, but not having a glassy surface. As such, the body fracture surface is distinguishable from a conchoidal glass, vitrified porcelain, or obsidian fracture surface. After firing, the resulting base slab material may, but need not, be cut, honed or polished to preselected dimensional thickness or surface smoothness.

Although reference is made to an FHD/S body material produced in the form of a slab (which is a thick sheet), it should be understood that any other suitable shape of the body material may be produced by the process, such as: a rectangular bar or “log”, a cylinder; a prism (triangular as seen in cross section); a ribbon; a platter having any desired geometrical shape (as seen in plan view), e.g., round, square, hexagonal, rectagonal, pentagonal, rhombic, cone shaped, and the like; a cube; a sphere, half-sphere or bowl; and the like.

### Body Fusion Process:

In accord with this invention, compound, monolithic 3-D shapes are constructed by fusion of multiple pieces, parts or segments of the same FHD/S body to each other, prior to the glazing steps described below. It is within the scope of this invention that different formulations of an FHD/S body may be produced. Accordingly, since different FHD/S bodies may have somewhat different CoEs, it is preferred to produce the compound shapes from multiple pieces of the same body composition so that the CoEs match. This will insure against inducing stress at the bond interface between pieces, which could result in bond failure and cracking apart of a compound structure in service.

The invention includes both unglazed and glazed fused 3-D FHD/S products. In a first aspect of the invention, by way of example, a fired FHD/S body piece is produced, e.g., as set forth above. Then, in a second aspect of the process, the fired monolithic FHD/S piece is cut, as needed (see description below for the customizing steps), assembled and fused in a second firing to form a monolithic, unitary 3-D finished fused product, for examples: a back-splash, pedestal sides, a front edge overhang, an inset wash basin or raised (above surface) bowl shape.

Taking a back-splash as an example, the FHD/S body formed as a slab is sectioned along one edge to provide a piece corresponding to the height of the backsplash, e. g., 4-6″ in width to form the back-splash of 4-6″ in height. The surfaces of the slab parts, at least in the area along one edge where the back-splash is to be fitted, are honed or polished smooth so the back-splash lower edge and the upper surface of the slab have a precision join. The slab and back-splash are introduced into a furnace and fixtured so that the back-splash is supported in a 3-D position orthogonal to the slab with the mating join surfaces in contact. The supported pieces are then fired (second firing) at the rate of from about 250° F./hr to about 500° F./hr up to a peak temperature in the range of from about 2000° F. to 2300° F. The peak temperature is held for from about 1 hr to about 5 hrs, in a normal oxidizing atmosphere.

Unexpectedly, I have discovered that this preparation and firing schedule (2^{nd} firing) results in the closely contacting FHD/S body pieces becoming fused together, without the need for flux or glaze bonding layer between them to form a monolithic, 3D compound structure. An even more unexpected result is that the resulting fusion bond is as strong as the original body material, and the join has an essentially imperceptible seam. The result is a truly compound, 3D, monolithic unitary FHD/S product, made by construction rather than casting, yet which has the properties of the base FHD/S body materials.

In destructive testing, the back-splash can be broken from the slab, but the back-splash section does not separate from the horizontal slab section at the join between them. Rather, a conchoidal break is produced in the base slab (body) material rather than separation occurring solely at the join line. The fusion bond is robust, in that the break does not occur at the plane of the original, unfused contact between the pieces. That is, the fusion bond interface plane is not the breaking surface. Nor do cracks propagate from the blow point to the join area. In short, the resulting fabricated, compound, 3-D FHD/S pieces are truly monolithic, unitary, are extremely robust, and the fusion join(s) are not points of weakness.

It should be understood that as an alternative, the invention comprises use of a small amount of a suitable flux applied to the contact area of one or more of the mating surfaces of the parts to assist in forming a fuse-bond, e.g., in cases of less smooth mating surfaces, or where the fusion temperature is required to be reduced or the peak temperature dwell (hold) time is to be reduced. Suitable fluxes for the high-SiO2 body compositions of this invention include compounds or compositions containing alkali metal oxides (Na, K) or alkaline earth metal oxides (Ca, Mg), such as a feldspar, nepheline syenite, dolomite, commercial flit fluxes, and the like. While Li, Sr, Ba, Zr and B-containing fluxes may be used, they are less preferred as being more costly. Finely ground, powdered FHD/S body material may also be used in place of a flux, applied to one or more of the mating surfaces.

Thereafter, the fused compound piece can be glazed and fired (third firing) as described below. In the alternative, a glaze composition is applied to the visible surfaces of the FHD/S body pieces in assembled position, and the fusion and glazing occurs in a single step (second firing only). In another alternative, the individual pieces may have glaze composition applied to the exposed surfaces, then they are fixtured and fired in a single glaze and fusion firing. However, since the glaze firing may have a different firing schedule with a lower end-point than the fusion firing, ordinarily fusion firing occurs first (second firing), followed by glaze application and firing (third firing). Use of a flux can permit single fusion and glazing firing.

### Custom Dimensioning and Glazing Process:

The custom finishing process steps proceed as follows, taking by way of example a custom kitchen counter top: Precise measurements are taken at a job site or drawn per specifications for the installation. The FHD/S body material dimensions do not shrink during fusion firing. Thus, the dimensions on site may be taken as the dimensions for the finished, fused product. Where the installation is against a wall, the wall (longitudinal) edge should be gauged (profiled in plan view) to determine if it is straight, and if not, the raw slab is cut to match the gauged profile. The adjusted pattern is laid out on the slab and the slab is cut at a fabrication facility, e.g., by means of a diamond saw, water jet, or the like. The back-splash section is also cut to match the slab, the mating surfaces polished to be flat, the parts are fixtured in position in contact, and then are fusion fired as described above.

The pattern cutting includes holes for the sink and the faucet, and any other purpose-dedicated holes, notches, relieved-areas and unique custom profiles. Because of no shrinkage during fusion firing, the pattern may be used for the product dimensions. However, when a glaze is applied, dimensional compensation for the glaze thickness may be needed. Since glaze is not applied to the back side or bottom of surfaces or back-splashes, normally, no dimensional compensation need be made. However, when the fitting to an appliance requires precision clearance, e.g., a hole or cut-out, the hole may need to be enlarged from 1-2 mm to compensate for glaze thickness in the hole bore, if the bore is to be glazed. Likewise, when an under-mount sink is to be installed, the sink cut-out is cut approximately 2 mm wider in both dimensions, width and length (not depth, as distinguished from thickness) to compensate for any glaze that is applied and fired. For unglazed installations, no compensation is needed.

The pre-glazed cut raw FHD/S slab pieces may be taken to the job site for checking, or the as-cut dimensions checked against the pattern. For a unitary, compound, 3D piece, the backsplash is then fused to the base countertop piece along its back edge, as described above. Then the customer, contractor, architect, interior designer or artist selects a glaze or “stain” color, glaze type (oxidized or reduced), lustre (e.g., matte, gloss, crystalline, metallic), artistic design, texture, pattern, or machined surface finish. As used herein, the reference to “stain(s)” means the colorants used in the glaze or body composition to impart color. A wide range of stains and glazes may be obtained from commercial suppliers, such as Ferro Corp and Mason. The selected glaze(s) or stain(s) are applied to the upper surface and exposed edges (work or visible surface) of the pre-cut slab(s), which is/are then fired in an appropriate firing schedule. The glaze/stain composition is selected to fit the slab body so that the glaze/stain is subject to from zero to a suitably small amount of compression. The slab/body material has essentially zero shrinkage upon glaze/stain firing, so that the pre-cut dimensions are retained.

It should be understood that the inventive process includes custom glaze finishing of free-standing pieces, such as lavatory counter-tops that are free standing on bath vanities or pedestals.

These free standing pieces may be made to standard dimensions, such as 36″, 40″, 48″, 60″, 72″, 84″, 96″, etc., wide and standard depth of from 19″-30″ deep. However, in accord with the invention, the holes for drop in or under-mount sink and faucets are cut in the monolithic FHD/S body before glazing, and the front and side edges glazed, as well as the holes are glazed. Or, following the fusion aspects of this invention, sink, back-splash, front edge, etc portions are fused to the main horizontal slab body before glazing.

The glaze is also selected and compounded so that there is minimal build-up, thickening, “drip”, or runs on vertical surfaces, and minimal thinning or “pull back” at corners such that the underlying color of the body shows. In the case of fused pieces, the glaze is continuous, and the slight fusion join becomes invisible. In contrast to granite and other engineered slab materials, no seam sealing is needed at the join lines of the glued-together individual parts.

In addition to glazing and staining, an engobe or slip trail design may be applied. Likewise, an artist may “paint” a design or picture with glaze(s) or stain(s), resulting in a unique artistic decorative surface for a solid surface installation, such as a cocktail bar, table, vanity top, kitchen counter, back-splash, or other architectural surface. A back-splash may have a different color or texture glaze applied to it, as distinct from the main horizontal work surface. Appropriate additives are employed in the glaze composition in the case of brushing to prevent too-rapid drying of the glaze. Taking a café table by way of example, a glaze artist can glaze-paint for example, Vincent van Gogh's “Café Terrace at Night” scene onto the top surface. Indeed, each table in a café or restaurant may have a different glaze-painted scene.

It will also be appreciated that being glazed, the resulting custom surface is hard, heat resistant, abrasion resistant, impervious, resistant to typical culinary and household acids and alkalis. In addition the glazed surface is particularly resistant against UV fading, unlike acrylic polymer type solid surfaces. The rigid and very robust body material, having a thickness no more than the typical granite slab, and the strength to be self supporting, will not flex, preventing initiation of glaze flake-off.

The inventive process includes post-glazing surface texturing, such as diamond brushing of selected portions of the glazed surface to impart a “leather” look, to reveal crazes of the glaze for an antique effect, honing to reveal a contrasting or complementary underglaze, body or engobe color.

In addition, a second over-glaze, such as a transparent over-glaze may be used to seal or add dimension to the surface of crackle, or diamond-brushed crackle glazes to produce a leather look and texture. Alternately, crackle glazes may be surface sealed with standard silicone sealants.

Still further, high titanium glazes may be lightly torched or “flame brushed” to impart brilliant metallic rainbow effects, akin to oil sheen on water. The flame finish refracts light into a full spectrum of colors, reds, blues, greens, yellows, violets, magentas, blacks, greys, and the like. Thus, the designer or artist effectively “paints with flame” to produce a highly unique, custom artistic piece on the large monolithic solid surface products of this invention. Such pieces are primarily suitable as architectural wall or horizontal surfaces, but also may be used as contact and support surfaces, such as bar tops, side board tops, café-table tops and the like.

As noted, glazing the 3-D finished FHD/S piece is optional. The FHD/S body material may include selected colorants to add a uniform color to the entire body, or by appropriate mixing of the powdered colorant, a swirl of colors is produced throughout the body. Thus, the resulting unglazed, fused 3-D product may be installed without glazing, and the body material color, e.g., white, cream, tan, grey, off-white, brown, bi-color, multi-color, etc., becomes the look of the finished, installed piece. Since the fusion seams are essentially invisible, there are no detracting grout lines between orthogonal pieces, even with an unglazed 3-D fused product.

After shop-finishing as described above, the finished, glazed or unglazed 3-D FHD/S piece is transported to the work-site for installation. Because of the body stability upon fusion and/or glaze firing(s), the pre-fusion/glazing-cut-to-dimensions are well within tolerances for the installation and fitting of appropriate appliances, in the case of the exemplary countertop, the installation of faucets and sprayers. The result is a custom FHD/S countertop having unitary, monolithic 3-D features that does not require any substantial cut-to-fit-work on the job-site.

Accordingly, the invention opens the door for an incredible range of artistic design and creativity that can be applied to large solid surfaces on a piece-by-piece, truly custom basis, to satisfy the requirements of discerning home owners and commercial establishments requiring compound, monolithic, unitary, 3-D, highly robust, architecturally and artistically unique surfaces. The unglazed and glazed large solid surfaces of this invention do not have the disadvantageous distractions of grid-works of grout lines evident when using small glazed tiles, nor the upkeep of the grout, yet is robust. The inventive products have all the advantages of the highest quality porcelain yet are more robust, being stronger and more blow-resistant. In addition, unlike mass-produced surfaces wherein the customer has only a limited range of selected colors and granulation/crystal types, the inventive process and glazed/unglazed 3-D FHD/S products are one of a kind, unique and bring an artistic dimension into the field of large architectural solid surfaces.

### BRIEF DESCRIPTION OF THE DRAWINGS

The invention is described in more detail with reference to the accompanying drawings and photographic illustrations. This patent or application file contains at least one drawing, as a photo, in color. Copies of this patent or patent application publication with color drawing(s), as photo(s), will be provided by the Office upon request and payment of the necessary fee.

Photos in the parent priority application Ser. No. 15/009,548, published on Aug. 11, 2016 as US 2016-0230396, are not repeated here, but are incorporated by reference to the extent needed for support.

FIG. 1A is a flow sheet outlining the steps of the basic FHD/S body production;

FIG. 1B is a flow sheet outlining the steps of the forming a 3-D monolithic, unitary product by fusion of FHD/S parts placed in contact, both with or without glazing;

FIG. 2 is a photographic illustration of two Samples, A and B, of different composition FHD/S body material before fusion or glazing has been applied;

FIG. 3 is a photographic illustration, in color, of an unglazed, fused monolithic 3-D FHD/S product of the invention as seen in % elevated view to show the interior angle of a vertical back-splash as it joins a horizontal base piece, both materials being Sample B body materials;

FIG. 4 is a photographic illustration, in color, of several unglazed, fused samples of different color FHD/S body material, illustrating that the fusion line is faint at best; Sample C on the left being two pieces of white FHD/S body material B fused to each other, Sample D in the center being a white upper FHD/S piece fused to a beige lower FHD/S piece, both being body material B, the join line being defined by the color boundary of the respective pieces: and Sample E on the right being a white upper FHD/S piece fused to a black lower FHD/S piece, both being body material B;

FIG. 5 is a photographic illustration, in color, of a glazed piece of Sample B FHD/S body material, the glaze being a transparent pale green crackle glaze;

FIG. 6 is a photographic illustration, in black and white of the fused FHD/S product of FIG. 3 which has been destructively tested to break the vertical back-splash segment from the base segment and illustrating that the break does not occur at the fusion join interface;

FIG. 7 is a photographic illustration, in color, of the exposed, broken edge of the base FHD/S body segment shown in FIG. 6 showing that the break is conchoidal in nature and not along the fusion join interface; and

FIG. 8 is an SEM photographic illustration, in black and white, of a segment of the fusion bond interface between the two FHD/S body parts of Sample D.

### DETAILED DESCRIPTION OF THE INVENTION

The following detailed description illustrates the invention by way of example, not by way of limitation of the scope, equivalents or principles of the invention. This description will clearly enable one skilled in the art to make and use the invention, and describes several embodiments, adaptations, variations, alternatives and uses of the invention. The disclosure of the parent priority application, Ser. No. 15/009,458, including text, photographs, Examples and glaze composition examples, are incorporated by reference herein to avoid needless enlargement of this specification.

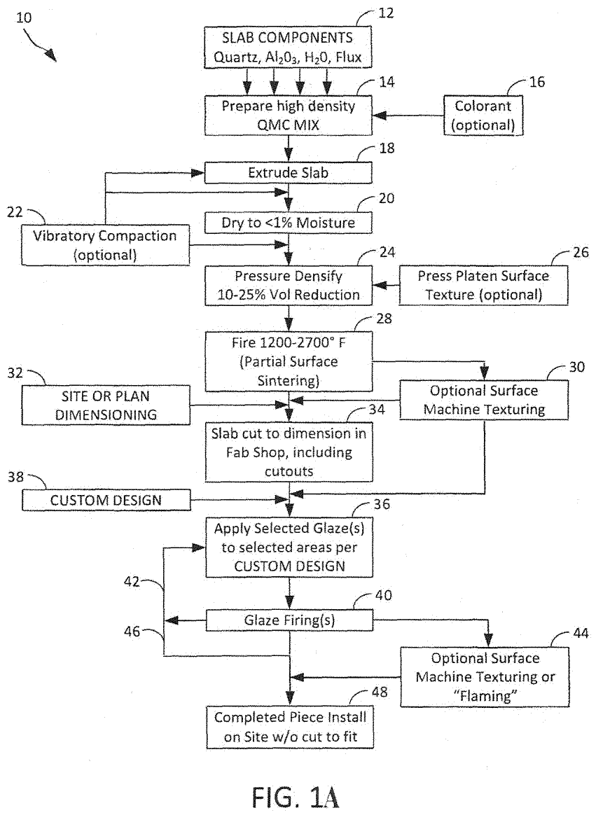

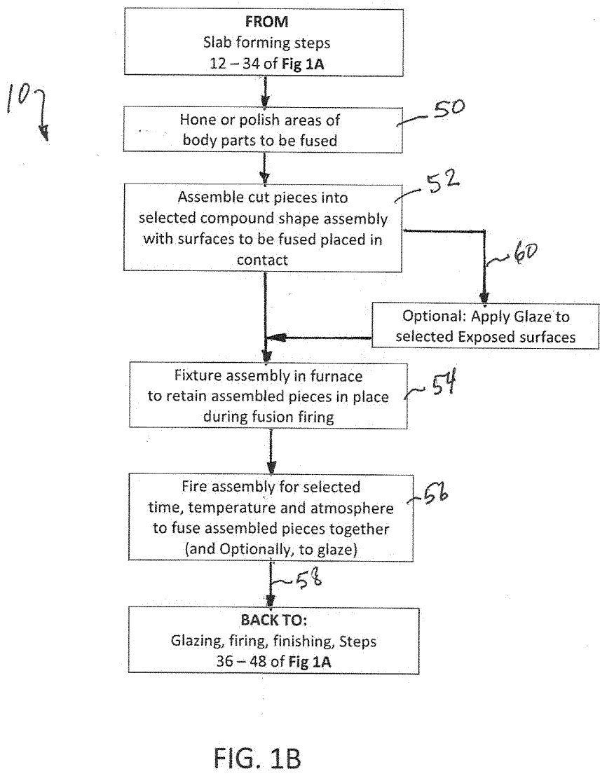

FIG. 1A shows the steps of a first process embodiment of the invention in flow-sheet format for preparation of an FHD/S body in slab form. The inventive process 10 begins with selection and weighing out of the components 12, preparing a damp or wet mix 14, and where a body color is desired, a colorant such as a stain or oxide, is added at 16. A body slab is extruded that is up to about 20% oversize (as compared to finished slab dimensions, to compensate for water content and size reduction due to compression to densify) at 18. The rough damp slab is dried to less than about 1% moisture by weight at 20. Optionally, during one or more of the extrusion and drying steps, vibratory compaction at 22 may be employed. The resulting green slab is then densified by compression under pressure sufficient to result in a 10-25% volume reduction at 24. During the densification step 26, a surface texture optionally may be imparted to the upper and/or lower surfaces of the slab in a platen or roller press, at 26. The densified, dried green slab is then fired at 28 in the range of from about 1200-2700° F. for a time sufficient to provide a partial surface sintering of the mix particles to each other. After firing the slab is cooled and is now a gauged (thickness), fired undecorated FHD/S slab. Optionally, one or more of the surfaces may be machine textured at 30, which can also serve to provide a precise dimensional thickness to the slab, e.g., 3 cm for countertops and to provide a custom edge contour. The fired FHD/S body slab 28/30 may be stored for inventory, or moved on to the next phase of processing.

In the next phase, site or plan-based dimensions are developed at 32 for a unique custom job. The gauged, fired FHD/S body slab 28/30 is then cut to dimension at 34 in a fabrication shop, including cut-outs and dimensional allowances for exposed glazed surfaces, e.g., outer exposed edges, and cut-out edges for under-mount sinks and the like. The optional machine texturing 30 of selected surfaces or edges may be done at this stage as well. Then one or more selected glaze compositions is/are applied to selected areas 36, in accord with a custom design 38. The glaze is fired at 40 pursuant to a firing schedule appropriate for the slab body and glaze composition. As shown at optional steps 42, 44 and 46, a second glaze may be applied and fired, including after an intermediary surface texturing by machine or “flaming” at 44. An example is diamond brushing of a crackle glaze laid down and fired at steps 36 and 40 to produce a leather texture look, optionally followed by a thin clear over-glaze or silicone sealant at 46 to seal the expose crackle grooves produced by the diamond brushing. The completed piece 48 may be installed at the site without the necessity of cut-to-fit, since the glaze firing did not result in slab shrinkage.

In accord with this invention the FHD/S slab produced in the FIG. 1A process at stages 32, 34 or 38 (including optional machine texturing at 30) is then processed to form a fused 3-D monolithic product as shown in FIG. 1B. By way of example, a kitchen or bath countertop is produced. The cutting to dimensions at 34 of FIG. 1A includes cutting of a back-splash portion from one edge of the larger FHD/S slab. Then the areas of the back-splash piece and the base horizontal countertop that are to be fused are honed or polished to produce precision flat mating surfaces at 50.

In this example, the bottom edge of the back-splash piece is honed or polished flat, and a top marginal edge of the countertop slab that is the width of the back-splash is likewise honed or polished flat. These FHD/S pieces are assembled as required into the compound 3-D shape at 52, with the honed or polished surfaces in contact. The assembled piece is fixtured in place at 54 in a firing furnace to retain the pieces in the required contact to permit fusion to be effected. The fixture assembly is fired for a selected time at a selected firing schedule at step 56. An exemplary firing schedule is 400° F./hr to a maximum firing temperature in the range of from about 2000° F. to about 2300° F., and held at the peak temperature for on the order of 1-5 hours to effect fusion. The result is an unglazed 3-D monolithic compound FHD/S product 58, in this example, a kitchen or bath countertop that includes an integral back-splash. This piece may be installed as-is on site, see FIG. 1A, step 48.

In an important option, the fused FHD/S product 58 may then be glazed and refired, as shown in steps 36-48 of FIG. 1A. Alternatively, glaze may be applied to the assembled pieces or fixture pieces at 60, and the fusion firing also serves as a glaze firing, in cases when the glaze can handle the fusion firing schedule. The glazing also serves to cover any minor “seam” lines at the fusion interface between two or more pieces.

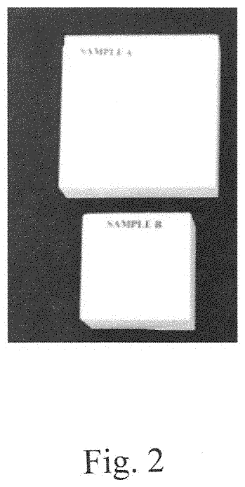

FIG. 2 shows two Samples, Sample A and Sample B of different compositions cut from base FHD/S slab materials as produced by steps 12-28 of FIG. 1A. Sample A is a white body, approximately 3″×3″ by 1.3 cm thick, with one side polished and the other honed smooth and planar. Sample B is an off-white, pale grey-white FHD/S body approximately 2″×2″ by 2 cm thick, both sides honed smooth and planar.

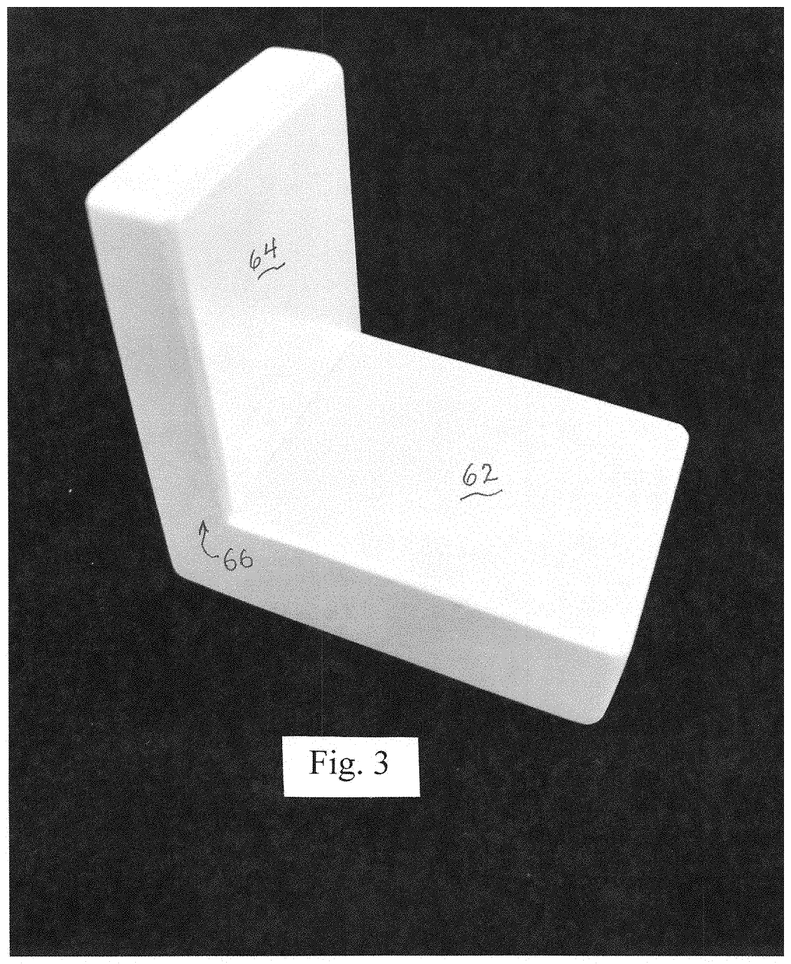

FIG. 3 shows a fused FHD/S compound 3-D) product following the process steps of FIG. 1B, formed from a base piece of Sample B FHD/S body material 62 onto which has been placed a back-splash section 64 of Sample B FHD/S body material. The respective mating surface of each piece was honed smooth and planar. The assembled piece was fixtured in a kiln and fired per steps 54 and 56 of FIG. 1B, the firing schedule being 400° F./hr to a peak temperature in the range of 2100° F.±100° F. at which temperature the assembly was held for from 1-2 hrs to effect fusion of the pieces together, and then the assembly was let cool overnight about 10-12 hrs. FIG. 3 shows the resulting fused 3-D compound monolithic FHD/S product corresponding to 58 in FIG. 1B. As noted by arrow 66, no join line is discernable at the plane of the original mating surfaces, indicating excellent fusion into a monolithic compound FHD/S product.

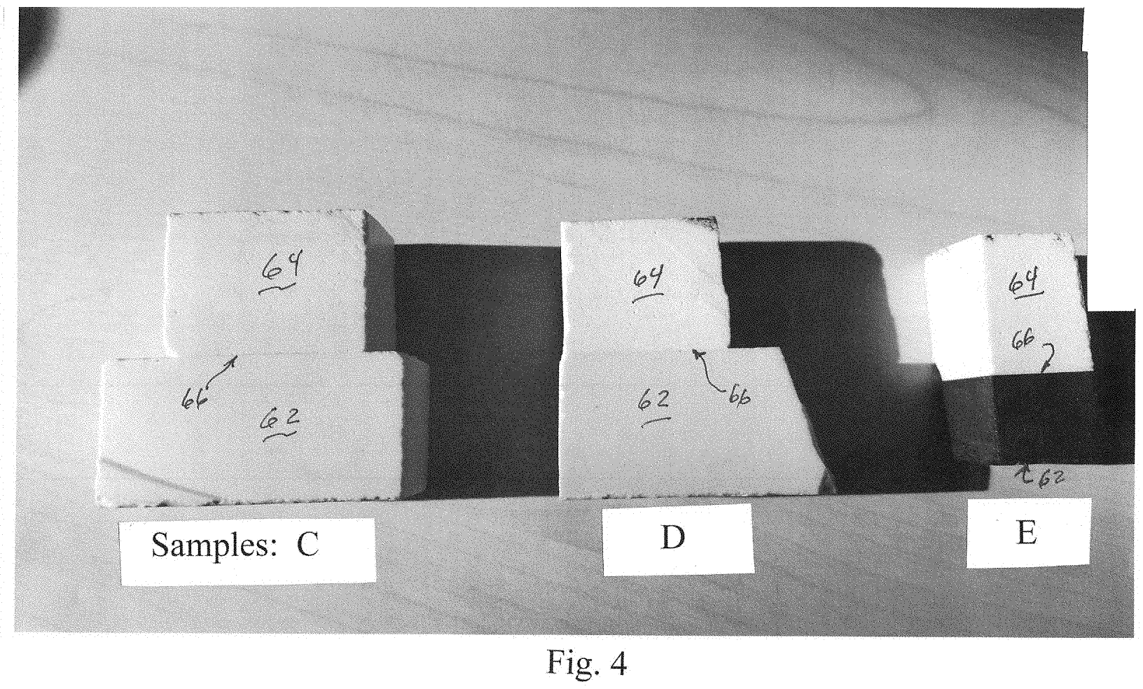

FIG. 4 shows a series of three additional FIG. 1B-process fusion Samples C-E, all using Sample B FHD/S body material: Sample C has a base piece of FHD/S material 62 onto which a piece of FHD/S material 64 (See FIG. 2 above) has been fused. Because of the slightly differing color of the body materials, only a faint join line is discernable at 66. Sample D is a base piece of cream colored FHD/S body 62 onto which a piece of Sample B FHD/S body material has been fused. Of course, the materials being different color, the plane of the mating surfaces 66 is visible, but there is no thick seam, and each piece retains its integrity. Sample E is a base piece of black-stained FHD/S Sample B body 62, to which a piece of unstained Sample B FHD/S body material 64 has been fused. As with Sample D, the plane of the mating surfaces is visible, but only because of the difference in the FHD/S body material color. These samples show that a complex shape, even a lavatory or kitchen sink, can be constructed by assembling graduated sized annular pieces, stacked one on the other in decreasing size to form a rough, stepped bowl (inverted), and fused in that orientation, after which the steps of the inner surface are ground to produce a smooth bowl shape. The resulting bowl may be fused to the underside of a counter-top slab having a suitable sized and located cut-out. Or the assembled stacked graduated pieces may be fused to the slab in a single firing operation.

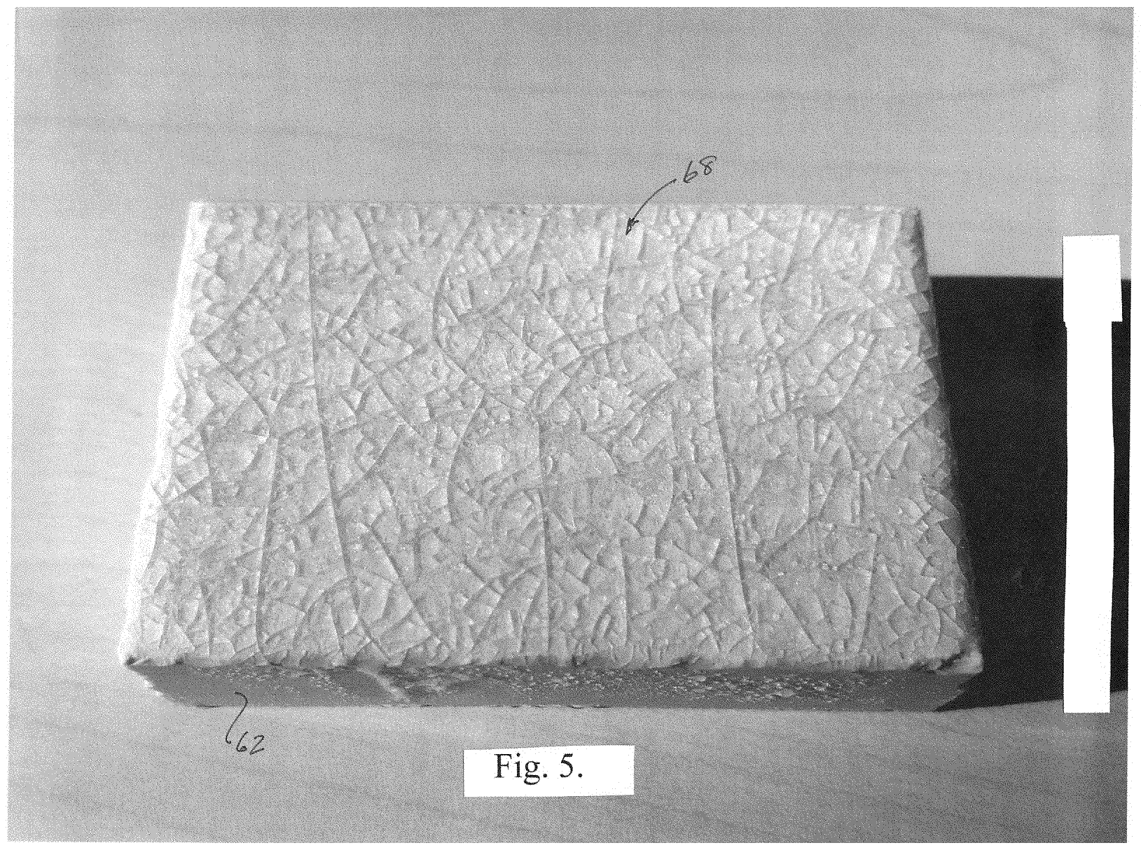

FIG. 5, Glazing Example 1, shows a sample of Sample B FHD/S body material 62 that has been glazed at 68, following steps 36, 40 of FIG. 1A, with a green crackle glaze of the following composition using copper carbonate to provide the green colorant:

Clear Crystalline Glaze

| | |
|---|---|
| Ferro Frit #3269 | 91 |
| Bentonite | 4 |
| Lithium Carbonate | 5 |
| Cryolite | 1 |

The glaze adheres well to the body and the crackle may be sealed with a conventional silicone sealant. This is glaze composition F of priority publication US 2016-0230396, published on Aug. 11, 2016, now U.S. Pat. No. 10______, modified with the colorant.

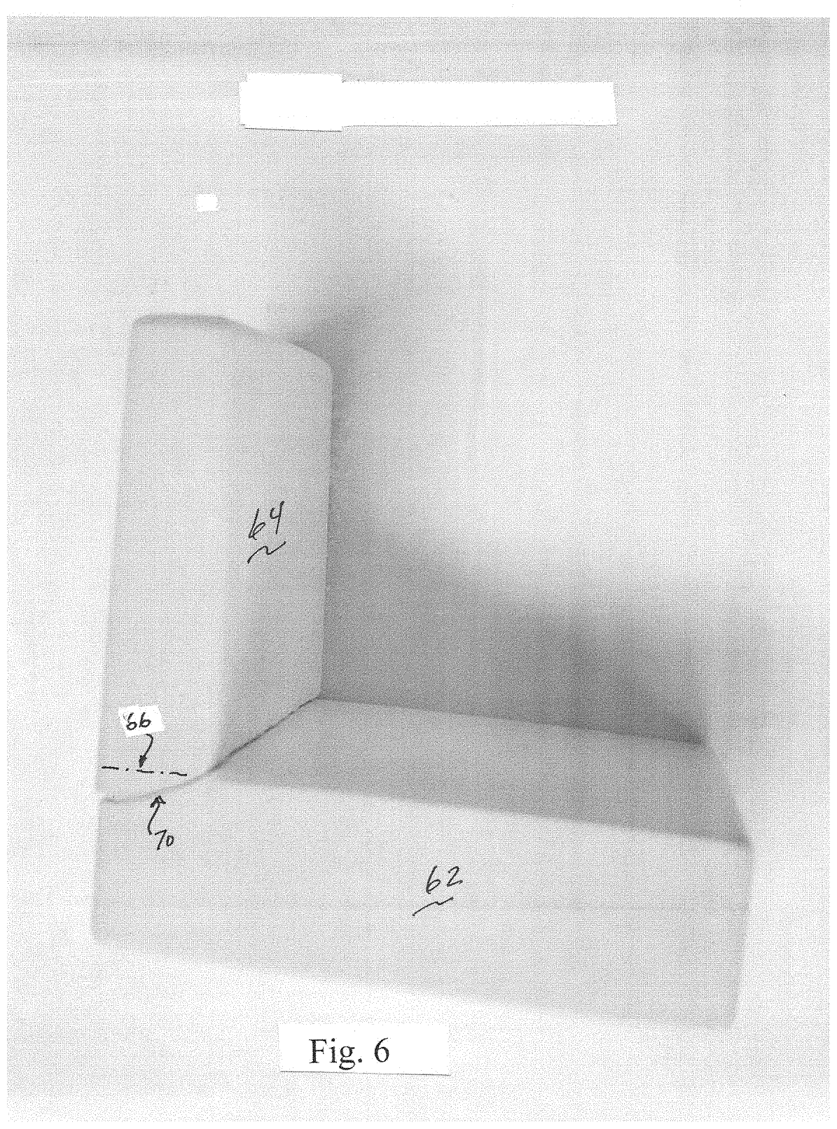

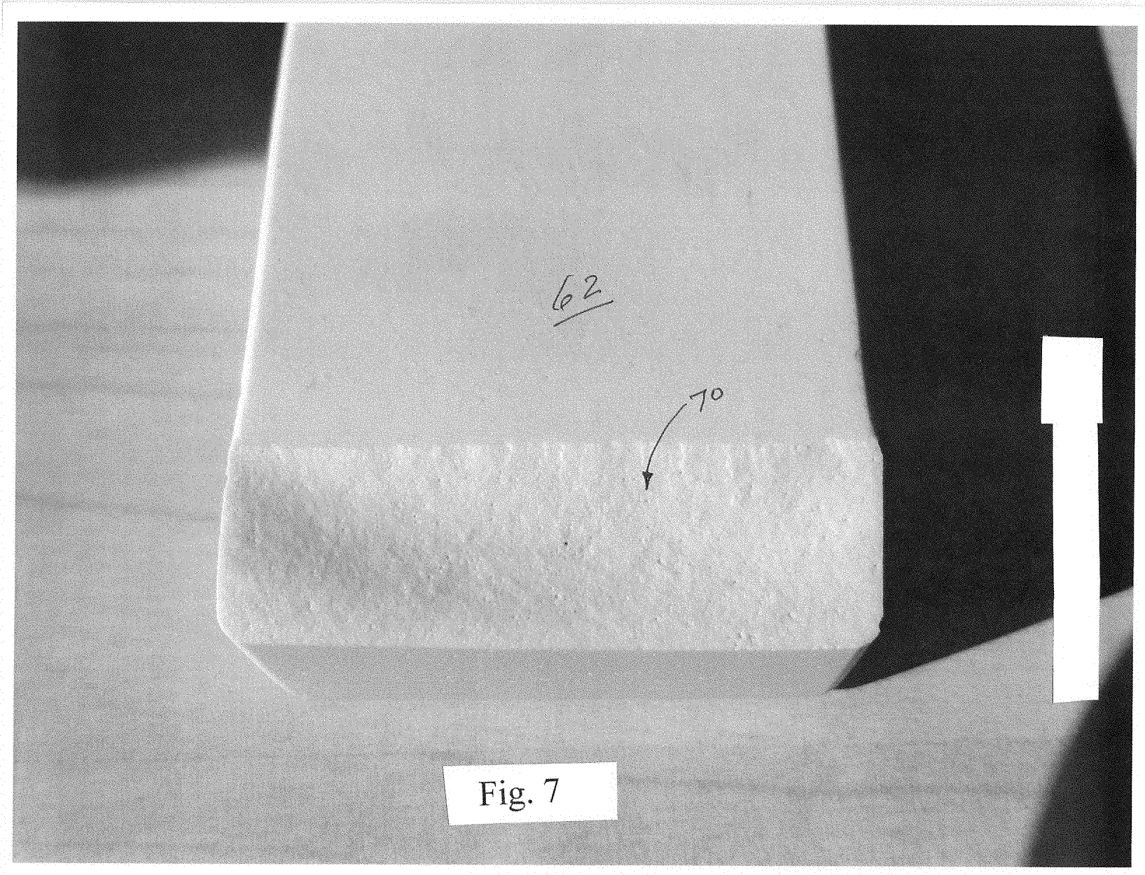

FIGS. 6 and 7 show destructive testing of the fused join of the FIG. 3 compound 3-D monolithic FHD/S product having a base portion 62 and a back-splash portion 64. For the test, the right angled fused assembly was inverted in an upside-down orientation, thus: A, and the apex was struck with heavy mallet until the pieces separated as shown along fracture 70 in FIG. 6. It is significant that the FHD/S parts did not separate along the original mating surfaces plane, indicated by dash-dot line 66; rather, the base fractured cleanly away from the back-splash section, and the fused assembly did not shatter into multiple small pieces. The conchoidal fracture surface 70 of the FHD/S body is shown in FIG. 7. It is not a glassy conchoidal fracture. Rather, examination of the fracture surface shows the nature of the body to be finely grained, highly uniform and dense. Indeed, this test also demonstrates that the fused assembly is robust.

### Glazing Example 2

Following the Steps of FIG. 1A, a gauged, FHD/S slab (28 of FIG. 1A) having the dimensions of 3 cm thick, by 130″ long and 58″ wide is selected for a horizontal kitchen counter-top. Following Steps 32-40 of FIG. 1A, a job site is measured, a template created and the FHD/S slab is cut in the fab shop to the job-site measure, including cut-outs for under mount sink, faucet water supply and sprayer holes, and an angular (45°) join-cut for a horizontal counter L-section (which backs against a side wall). In addition, a double ogee pattern is machined on the outside front edge. The sink cut-out is over-sized since glaze will cover the vertical edge, the sink chosen being an under-mount sink. The counter L-section FHD/S slab is cut per the required measure, including a matching join-cut, double ogee on the exposed front and end edges, and a cut-out for a drop-in range top. A third FHD/S strip, 6″ high by 120″ long, is cut for a backsplash of the sink section. The top edge of the countertop slab cut-out for the sink is chamfered so the sink cut-out edge is rounded. Optionally, that vertical edge may be machined to form a desired ogee curved surface. In the case of an exposed island that mates orthogonally to the sink counter section, the respective join areas of the sink counter and island are left with a vertical, matching cut, and neither chamfered at their top edges nor machined with an ogee shape. However, the other three exposed 3 side edges of the island are ogee machined.

A back-splash or/and front edge piece may be fused to the back top surface and the front edge of the slab if desired to produce a compound, 3-D FHD/S monolithic sink assembly per the steps of FIG. 1B. The island section may also be fused to the counter section.

A suitable glaze is applied to the sink section, L-section and/or island sections, including any back-splash and front edge pieces, and then fired in an appropriate firing schedule to a suitable cone temperature, for a suitable time, such as cone 06 for 8 hours. The backsplash may have applied to it a glaze of different composition and color per the designer's specification. For example, the back-splash glaze may be crackle as seen in FIG. 5. The glazed pieces are compared to the pattern and found to not have expanded or shrunk out of tolerance. Since the sink is an undermount, the vertical edges of the sink cut-out are glazed, as are all exposed ogee front and end edge surface(s). In this example, per specifications, the back-splash crackle glaze is diamond brushed after glaze firing to provide a leather look that also reveals the fine crazing as part of the artistic appeal. The finished fused assembly is installed at the job site as a unitary 3-D compound-shape FHD/S monolithic piece.

Exemplary glaze formulations that may be used with inventive gauged, fused and fired slabs and 3-D assemblies as described above may be found in our co-pending priority published US application for patent, US 2016-0230396, published on Aug. 11, 2016, now U.S. Pat. No. 10______, the disclosure of which is hereby incorporated by reference, as may be needed.

The glaze of FIG. 5 is a clear crystalline glaze with mild crazing and can be colored with a wide rage of conventional stains and oxide colorants. For example, FIG. 5 (Glazing Example 1) uses Copper Carbonate for colorant to produce a pale green glaze. Optionally, this glaze can include up to about 5% of a flux or glass former such as Boron Oxide (e.g. as Boron Trioxide B₂O₃), K₂O, Na₂O, Li₂O, and the like, for greater visual depth to the crackle, possibly due to increased refractive index. It is particularly suited for post-firing machine texturing, e.g., by diamond polishing or brushing at step 44 of FIG. 1A, to produce a leather-look textured finish as described above in Glazing Example 1 for the back-splash piece. If desired, crazed glazes can be overglazed or sealed with standard sealants, such as are used for granite counter-tops.

The examples given above show that the inventive fused and glaze-fired monolithic high-density 3-D FHD/S assemblies have a uniquely custom look, texture and color palette. The glaze top surface layer is on the order of between from about 0.5 mm to about 4 mm in thickness, and is acid resistant, abrasion and impact resistant, and color-fast, permitting external uses in areas exposed to solar radiation without fading or degradation. The glaze layer provides an added layer of weather and use resistance to the base slab material.

It is also important to note that the unique glaze texture and artistic look of the inventive FHD/S surface slabs may be applied and fired to be continuous from a top surface over the front-facing fused face piece of a horizontal slab and up a fused back-splash piece. The brilliance, depth and unique look of the inventive 3-D fused monolithic glazed products cannot be achieved in an unglazed monolithic slab alone, not only top surface but also exposed edges, nor the range of palette choices and continuity of color, design, texture and depth.

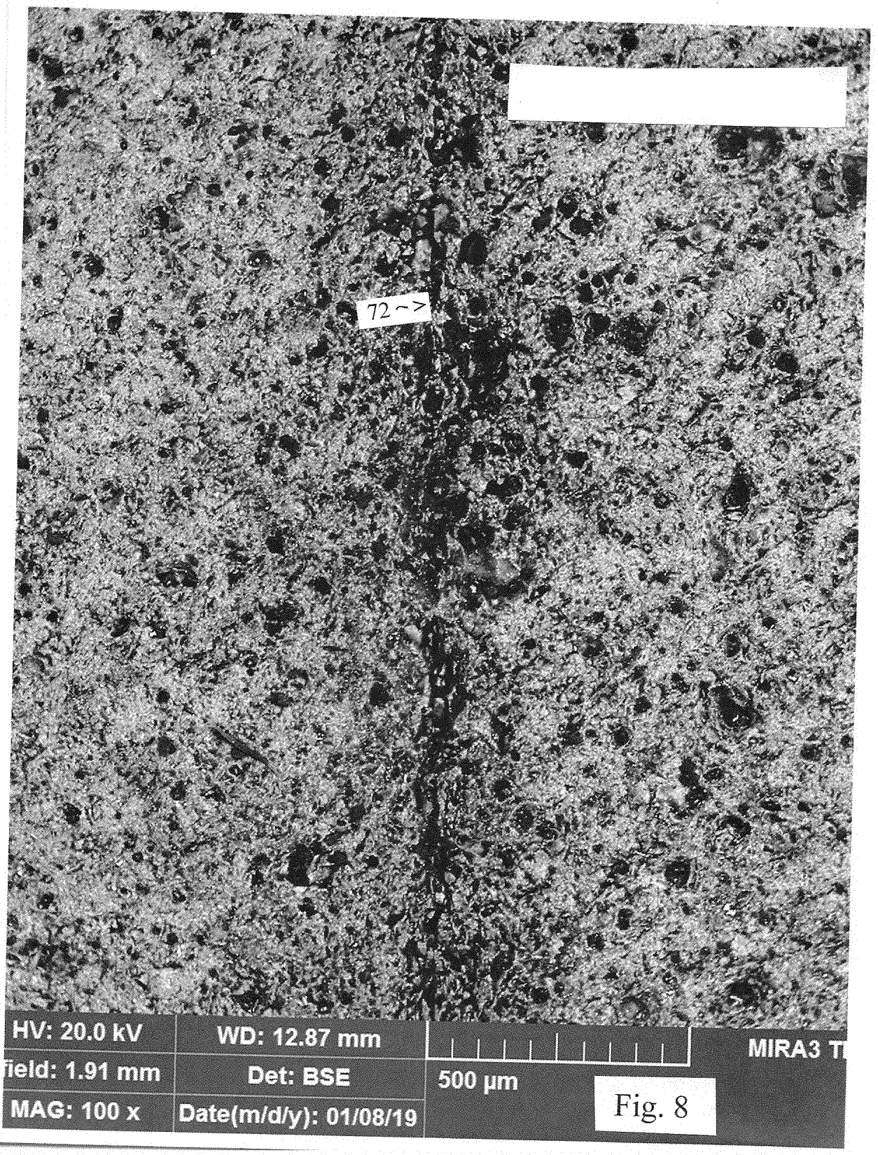

FIG. 8 is an SEM micrograph of a representative segment of the fusion bond between the pieces of Sample d at a magnification of 100×, the scale being at the lower right. The grains and crystals of the individual FHD/S pieces are visible, and the central dark, somewhat sinusoidal line central of the image and running from bottom to top, is the fusion bond interface 72. It shows that the bond ranges from less than 1μ, for example at the very top and bottom, and about 50μ in the center. The sinusoidal shape shows that there is also some mechanical interlock of the surfaces in association with the glassy bond phase.

### INDUSTRIAL APPLICABILITY

It is clear that the inventive fusion process and fused or/and glazed 3-D FHD/S products of this application have wide applicability to the construction and interior design fields, namely to bringing custom design, including a full range of artistic and design creativity to large slab surfaces.

It should be understood that various modifications within the scope of this invention can be made by one of ordinary skill in the art without departing from the spirit thereof and without undue experimentation. For example, the fused 3-D FHD/S assemblies with their optionally glazed surfaces can have a wide range of functional and artistic designs, yet retain the functionalities disclosed herein. Surfaces may be treated with anti-bacterial compositions or compounds, such as inorganic Ag or TiO2-containing compositions, or organic biocides and anti-bacterials. This invention is therefore to be defined by the scope of the appended claims as broadly as the prior art will permit, and in view of the specification if need be, including a full range of current and future equivalents thereof.

Parts List (This Parts List is provided as an aid
to Examination and may be canceled upon allowance)

| | |
|---|---|
| 10 Inventive Process | 82 |
| 12 Selection, weighing out components | 84 |
| 14 Dry or wet mix | 86 |
| 16 Colorant optionally added | 88 |
| 18 Dense slab or body shape extruded | 90 |
| 20 Drying extruded, densified slab or body shape | 92 |
| 22 Vibratory compaction (optional) | 94 |
| 24 Pressure applied - reduces volume and increase density | 96 |
| 26 Platen press to texture surface | 98 |
| 28 Fire dry body, partial particulate surface sintering | 100 |
| 30 Optional machine texturing | 102 |
| 32 Site or plan dimensioning | 104 |
| 34 Cutting slab or body shape to dimensions | 106 |
| 36 Glaze applied | 108 |
| 38 Custom design to be applied | 110 |
| 40 Glaze firing | 112 |
| 42 Optional overglaze | 134 |
| 44 Optional surface texturing or flaming of glaze | 136 |
| 46 Optional overglaze after texturing | 118 |
| 48 Completed piece installed | 120 |
| 50 Hone or polish areas of body to be fused | 122 |
| 52 Assemble pieces into 3-D shape, surfaces to be fused in | 124 |
| contact | |
| 54 Fixture assembly in fusion furnace | 126 |
| 56 Fire assembly in fusion firing schedule | 128 |
| 58 Return to Glazing, glaze firing, finishing Steps FIG. 1A | 130 |
| 60 Optional application of glaze to exposed 3-D surfaces | 132 |
| 62 Horizontal Base piece of fused assembly | 154 |
| 64 Vertical body piece of fused assembly | 136 |
| 66 Join plane of 62/64 not visible in fused piece | 138 |
| 68 Pale green crackle glaze on base body piece 62 | 140 |
| 70 Destructive testing conchoidal fracture in base 62, no | 142 |
| fracture along join plane 66 (shown in phantom) | |
| 72 Fusion bond plane micrograph at 100X | 144 |
| 74 | 146 |
| 76 | 148 |

1. A process for producing a custom unitary monolithic 3-D product comprising the steps of:
a) providing a plurality of fired body pieces formed of a high silica composition having in excess of 80% by weight SiO₂;
b) forming at least one planar surface area on selected ones of said fired body pieces, which, when assembled with selected ones of said planar surface areas in contact, form a 3-D assembly;
c) assembling selected ones of said planar surface areas of said parts in mating contact to form a 3-D assembly; and
d) firing said 3-D assembly at a temperature and for a time to fuse together said parts that are placed in mating contact, said firing producing a unitary, fused monolithic 3-D product.

2. A process as in claim 1 which includes the added steps of:
e) applying at least one glaze composition to at least selected surfaces of said unitary, fused monolithic 3D product; and
f) firing said glaze composition to produce a fused monolithic 3-D product having at least one area having a fired glaze surface.

3. A process as in claim 2 which includes a post-glaze firing step from at least one of over-glazing, machine finishing and flaming at least portions of said fired glaze surface on said fused monolithic 3-D product.

4. A process as in claim 3 wherein said fired glaze surface is a controlled crackle glaze, and said surface treatment machine finishing includes diamond brushing to produce a leather-like finish.

5. A process as in claim 3 wherein said post-firing step of flaming includes applying an open flame to selected areas of said fired glazed surface for a time sufficient to produce an iridescent finish.

6. A process as in claim 1 which includes applying a second, over-glaze to selected areas of said fired glazed surface to provide at least one of artistic effect, surface sealing, enhanced visual depth, or enhanced surface hardening, abrasion resistance, impact resistance and acid resistance.

7. A process as in claim 1 wherein at least one part comprising said monolithic product is processed to include on selected areas of said part, at least one of an engobe coating, a surface texture, and a surface relief.

8. A process as in claim 1 which includes the step of applying at least one glaze composition to at least selected surfaces of said parts prior to fusion firing.

9. A process as in claim 1 which includes providing a plurality of body parts having different colorants therein, and selecting different colored parts for fusion to produce a multi-colored monolithic 3-D fused product.

10. A process as in claim 1 which includes providing a plurality of stacked annular parts having different overlapping radial dimensions oriented in a generally bowl configuration, fuse-firing said parts in said stack to form a crude bowl shape, and finishing said fused stacked parts to provide 3-D products having a finished bowl configuration.

11. A monolithic, unitary 3-D product comprising in operative combination:
a) a plurality of body pieces having planar surface areas, each said body pieces comprising a fired, high density, high SiO₂ composition having in excess of 80% by weight SiO₂ and having compatible thermal coefficient of expansions; and
b) said body pieces being arranged into a 3-D assembly with said selected planar surfaces of said body pieces fusion bonded to each other to form said monolithic, unitary 3-D product.

12. A monolithic, unitary 3-D product as in claim 11, wherein at least some surface areas thereof include a compatible, fired-glaze surface coating thereon.

13. A monolithic, unitary 3-D product as in claim 12 wherein said fired-glaze surface coating includes a surface treatment selected from machine texturing and flaming to produce a leather-like or iridescent appearance.

14. A monolithic, unitary 3-D product as in claim 12 wherein said fired-glaze surface is selected from at least one of metallic, crazed, crystalline, gloss, matte, semi-gloss, eggshell, orange-peel, and satin looks.

15. A monolithic, unitary 3-D product as in claim 12 wherein said fired-glaze surface coating includes a design.

16. A monolithic, unitary 3-D product as in claim 15 wherein said design comprises a plurality of glaze compositions selected from at least two different colors.

17. A monolithic, unitary 3-D product as in claim 11 wherein said high SiO₂ composition, before firing, includes less than about 3% by weight moisture and less than about 1% by weight of an organic binder.

18. A monolithic, unitary 3-D product as in claim 17 wherein said SiO₂ is comprises crushed crystalline quartz material having less than about 2% by weight natural impurities, a lower particle size in the range of −325 to −200 USS mesh and an upper particle size ranging from about +50 to −20 USS mesh particles, and includes additives selected from at least one of less than 3% by weight Al₂O₃ as a binder, less than about 1% by weight ZrO₂ as a flux, a colorant, and kaolinite in place of up to 10% by weight of said quartz and Al₂O₃ components.

19. A monolithic, unitary 3-D product as in claim 11 which includes a plurality of different colored fused parts as a multi-colored monolithic 3-D fused product.

20. A monolithic, unitary 3-D product as in claim 11 which includes a plurality of stacked annular parts having different overlapping radial dimensions oriented, fused and finished into a bowl shape.
